(19) United States
(12) Patent Application Publication
(10) Pub. No.: US 2025/0117738 A1
(43) Pub. Date: Apr. 10, 2025

(54) FAN-IN AND FAN-OUT ARCHITECTURE FOR SUPPLY CHAIN TRACEABILITY

(71) Applicant: Microsoft Technology Licensing, LLC, Redmond, WA (US)

(72) Inventors: Vaishnavi NATTAR RANGANATHAN, Seattle, WA (US); Roberto Oliveira SANTOS, Curitiba (BR); Bruno SILVA, Clyde Hill, WA (US); Ranveer CHANDRA, Kirkland, WA (US); Riyaz PISHORI, Sammamish, WA (US)

(73) Assignee: Microsoft Technology Licensing, LLC, Redmond, WA (US)

(21) Appl. No.: 18/429,151

(22) Filed: Jan. 31, 2024

Related U.S. Application Data
(60) Provisional application No. 63/588,592, filed on Oct. 6, 2023.

(51) Int. Cl. G06Q 10/0833

(52) U.S. Cl. CPC G06Q 10/0833

(57) ABSTRACT

A supply chain tracking system utilizes tracking codes to track products through a supply chain. A tracking code is assigned to each product. If the product is grouped with other products at a stage in the supply chain, a tracking code is assigned to the group, and the tracking code for each of the products in the group is associated with the tracking code for the group. If the group of products is further aggregated with groups of other products, such as in a shipping container, a tracking code is assigned to the aggregated groups of products, and the tracking code for each of the groups of products is associated with the tracking code for the aggregated groups of products. The tracking codes are used to generate a supply chain graph which maps the travel of each product through the supply chain.

### BACKGROUND

The global and distributed sourcing of commodities has created the need to track raw materials through multiple stages of processing that involve aggregation and disaggregation. Taking the consumer appliance industry for instance, mobile phones which are sold in the US today often have their core chips designed in the USA but the parts themselves are manufactured in Taiwan with raw materials sourced from different parts of the world and assembled in China before they are shipped to the USA for sale. Furthermore, at the end-of-life of such a commodity, there is a huge incentive now to recycle and reuse some of the parts. The scale of such processes in time and space creates a challenging life cycle to keep track of. This example merely touches on a few of the steps of manufacturing and the processes can depend on multiple small-holder suppliers across the globe.

There are two challenges that appear in such a global supply chain. Firstly, tracking the parts individually through the aggregation and disaggregation stages has been a practical problem. Secondly, missing information from various stages poses a barrier to real-time, knowledge-based decision making for accountability, handling disruptions or certifications. There is an imminent need to overcome these challenges as regulations for global trade start necessitating the need to track and trace products across all supply chains.

### SUMMARY

In one general aspect, the instant disclosure presents a supply chain tracking system having a processor and a memory in communication with the processor wherein the memory stores executable instructions that, when executed by the processor alone or in combination with other processors, cause the supply chain tracking system to perform multiple functions. The function may include storing node information for a plurality of nodes of a supply chain graph in a database, each of the nodes representing a stage in the supply chain; receiving first product tracking information for a first product unit via a network, the first product tracking information including a first tracking code associated with the first product unit and indicating a first node for the first product unit; receiving second product tracking information via the network, the second product tracking information indicating that a plurality of product units have been aggregated to form a first aggregation of product units at a second node of the plurality of nodes and the second product tracking information including (i) a second tracking code associated with the first aggregation of product units and (ii) a first list of tracking codes for the product units in the first aggregation of product units, the first list of tracking codes including the first tracking code; and storing a first record in the database indicating a transfer of the first product unit from the stage associated with the first node to the stage associated with the second node, the first record corresponding to a first edge of the supply chain graph and including the first tracking code, the second tracking code, a first location code associated with the first node, and a second location code associated with the second node.

In yet another general aspect, the instant disclosure presents a method of tracking products in a supply chain using a supply chain tracking system. The method includes receiving a first notification indicating that a first product unit is to be added to a first stage of the supply chain, the first notification including first product information; determining a first tracking code for the first product unit; generating a first product record in a database for the supply chain tracking system, the database storing node information for a plurality of nodes of a supply chain graph representing the supply chain, each of the nodes representing different stages of the supply chain, the first product record including the first tracking code, the first product information, and a first location code for the product unit, the first location code for the product unit corresponding to a location code assigned to the first stage; receiving a second notification indicating that a first container unit is to be added to the first stage of the supply chain, the second notification including first container information; determining a second tracking code for the container unit; generating a first container record in the database for the supply chain tracking system, the first container record including the second tracking code, the first container information, and the first location code; receiving a third notification indicating that the first tracking code is associated with the second tracking code; updating the first product record to include the second tracking code and the first container record to include the first tracking code; receiving a fourth notification indicating a transfer of the first container unit to a second stage of the supply chain; updating the first product record and the first container record to include a second location code corresponding to a location code for the second stage; and generating a first transfer record in the database for the transfer of the first container unit to a second stage of the supply chain, the first transfer record including the first location code, the second location code, and at least the second tracking code.

In a further general aspect, the instant application describes a non-transitory computer readable medium on which are stored instructions that when executed cause a programmable device to perform functions of storing node information for a plurality of nodes of a supply chain graph in a database, each of the nodes representing a stage in the supply chain; receiving first product tracking information for a first product unit via a network, the first product tracking information including a first tracking code associated with the first product unit and indicating a first node for the first product unit; receiving second product tracking information via the network, the second product tracking information indicating that a plurality of product units have been aggregated to form a first aggregation of product units at a second node of the plurality of nodes and the second product tracking information including (i) a second tracking code associated with the first aggregation of product units and (ii) a first list of tracking codes for the product units in the first aggregation of product units, the first list of tracking codes including the first tracking code; and storing a first record in the database indicating a transfer of the first product unit from the stage associated with the first node to the stage associated with the second node, the first record corresponding to a first edge of the supply chain graph and including the first tracking code, the second tracking code, a first location code associated with the first node, and a second location code associated with the second node.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example computing environment in which the techniques disclosed herein are implemented.

FIG. 2 is a schematic illustration of an example supply chain tracking system which can be used in the computing environment of FIG. 1.

FIGS. 3A-3D show example schemas for database records used to store tracking data for supply chain tracking system of FIG. 2.

FIGS. 4A and 4B show simplified example implementations of user interfaces for adding and updating tracking information for the supply chain tracking system of FIG. 2.

FIG. 5 shows a schematic illustration of how tracking codes can be used for deterministic supply chain tracking.

FIG. 6 shows a schematic illustration of how tracking codes can be used for probabilistic supply chain tracking.

FIGS. 7A and 7B show example visualizations which are generated for visualizing tracking data in the supply chain tracking system.

FIG. 8 shows another example visualization which is generated for visualizing tracking data in the supply chain tracking system.

FIG. 9 is a block diagram illustrating an example software architecture, various portions of which may be used in conjunction with various hardware architectures herein described.

FIG. 10 is a block diagram illustrating components of an example machine configured to read instructions from a machine-readable medium and perform any of the features described herein.

### DETAILED DESCRIPTION

Supply chain tracking involves monitoring and managing the movement of goods and materials throughout a supply chain, from raw material suppliers to end customers. One goal of supply chain tracking is traceability. Traceability in supply chains refers to the ability to identify and track a product's entire lifecycle as it moves along the supply chain, from the origins of the raw materials all the way to the finished product reaching the end user. Traceability is an important aspect of ensuring quality control and sustainability. Knowing the complete history of a product and its individual components or materials significantly reduces the risk of product defects, recalls and returns which are damaging to a business's public image as well as finances. Furthermore, traceability is essential to know whether a product is truly sustainable. A product's sustainability needs to be assessed at every stage, including the raw materials, manufacturing and end-of-life (whether the product or its parts can be reused or recycled). It is only by analyzing the entire process that a company can take meaningful steps to reduce its environmental impact.

While tracking technologies and systems have advanced significantly in recent years, there are still several challenges and difficulties associated with supply chain tracking and traceability. For example, modern supply chains can be highly complex, involving multiple suppliers, manufacturers, distributors, and retailers across various geographic regions. Integrating and standardizing tracking data from these disparate sources can be difficult. Another difficulty faced in supply chain tracking is maintaining traceability of goods as goods are aggregated and disaggregated at various stages along a supply chain. Aggregation and disaggregation of goods can lead to loss of tracking data, making it difficult to trace goods back to their source. Missing tracking data poses a barrier to real-time, knowledge-based decision making for handling disruptions, accountability, and sustainability.

To address these technical problems and more, in an example, this description provides technical solutions in the form of a supply chain tracking system that can provide traceability through a complex supply chain system. The tracking system utilizes a fan-in fan-out model or graph that keeps track of changes in the product state and location along with descriptors of a product lifecycle. The solution presented involves the use of tracking codes to create a directed graph representation that can be stored in a database, such as an Azure SQL Ledger database. The directed graph represents the tracked location in the supply chain route, where each node is a location (e.g., farm, warehouse, manufacturing facility, transport vehicle, cargo ship, store, etc.), and each node is associated with a unique tracking code, referred to as a location code. Each product in a supply chain is tracked using a unique tracking code, referred to as a product code. When a product is at/in a location in the supply chain, the product code for the product is stored in association with the location code for the location. Product and location codes and associated tracking data are stored in a data structure, such as a table or database. In some implementations, codes and tracking data are stored in a ledger table of a Microsoft Azure SQL database. Ledger tables do not allow operations to update or delete an existing record. This restriction prevents changes in the product story and guarantees a reliable history track.

As the product moves through the supply chain, aggregations can happen, such as apples from different farms combined in a pallet in a warehouse. This scenario is represented in the graph as multiple nodes (farms) connected to one specific node (warehouse pallet). This operation is referred to herein as Fan in, and each edge between one of the farms and the warehouse is a new record in the ledger table. Disaggregation, which is also referred to herein as Fan out, happens when a large amount of product is divided into sub-groups. Following the example above, the pallet in the warehouse can be divided into packages of 1 kg of apples. In this scenario, one node (warehouse pallet) connects to multiple nodes representing the packages of 1 kg of apples. A code is updated every time there is a change in the product state and/or its location, namely aggregation (fan-in) or disaggregation (fan-out) at various stages and locations in the supply chain. Although the supply chain tracking system is described primarily for use in Agricultural Supply Chains, the supply chain tracking system according to the instant disclosure can be used for supply chain tracking and traceability of substantially any goods or raw materials.

The tracking mechanism described herein enables deterministic tracking of products as well probabilistic tracking of bulk products, such as grains and similar products. Another feature such tracking enables is the ability to carry forward descriptors, such as grain type information, sustainability certifications, quality metrics, stagewise growth, harvest, storage and transport conditions, and other data that is made available by the various entities in the supply chain. Such traceability can help improve efficiency in food supply chains and minimize loss. Traceability also enables real-time quality tracking for supply chain planning and quick recall implementation.

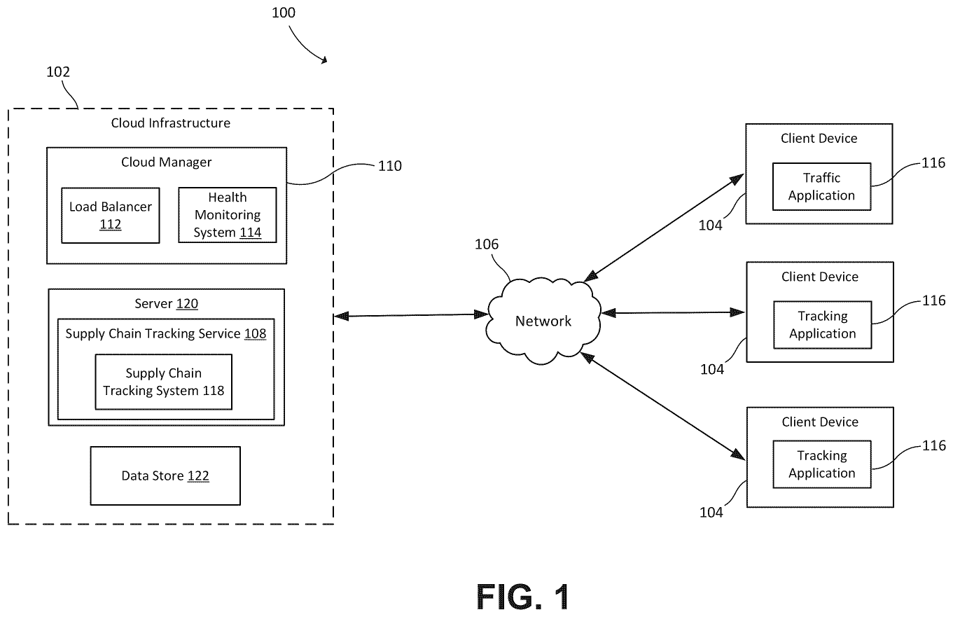

FIG. 1 is a diagram showing an example computing environment 100 in which aspects of the disclosure may be implemented. Computing environment 100 includes cloud infrastructure 102, client devices 104, and a network 106. The network 106 includes one or more wired and/or wireless networks. In embodiments, the network 106 includes one or more local area networks (LAN), wide area networks (WAN) (e.g., the Internet), public networks, private networks, virtual networks, mesh networks, peer-to-peer networks, and/or other interconnected data paths across which multiple devices may communicate.

The cloud infrastructure 102 is configured to provide one or more cloud computing services and/or distributed computing services to users over the network 106. The computing services include a supply chain tracking service 108 (explained in more detail below). Cloud infrastructure 102 may provide other services, such as hosting applications, user authentication, file storage, system updates, and the like. Cloud infrastructure 102 includes one or more servers 120 which are configured to provide computational and storage resources for the supply chain tracking service 108. Servers are implemented using any suitable number and type of physical and/or virtual computing resources (e.g., standalone computing devices, blade servers, virtual machines, etc.). Cloud infrastructure 102 may also include one or more data stores 122 for storing data, programs, and the like for implementing and managing the supply chain tracking service 108. In FIG. 1, one server 120 and one data store 122 are shown although any suitable number of servers and/or data stores may be utilized.

Cloud infrastructure 102 includes a cloud manager 110 for managing various aspects of the cloud infrastructure, such as deploying, configuring, and managing physical and/or virtual machines. Cloud manager 110 includes a load balancer 112 for distributing requests and workloads among server farms and/or among servers of a server farm. The load balancer 112 utilizes parameters such as load, number of connections, and server performance, to determine where to distribute the requests and workloads. Cloud manager 110 also includes a health monitoring system 114 configured to monitor the health of physical and virtual resources. and identify faulty components so that remedial action can be taken.

Client devices 104 enable users to access the services provided by the cloud infrastructure 102 via the network 106, such as the supply chain tracking service 108. Client devices 104 can be any suitable type of computing device, such as personal computers, desktop computers, laptop computers, smart phones, tablets, gaming consoles, smart televisions and the like. Client devices 104 include one or more client (software) applications that are configured to interact with services made available by cloud infrastructure 102. For example, client devices 104 include tracking applications 116 which enable users to interact with the supply chain tracking service. In some implementations, client applications include dedicated applications installed on the client device and programmed to interact with one or more services provided by cloud infrastructure. In other embodiments, client applications include general purpose applications, such as a web browser, configured to access services over the network 106.

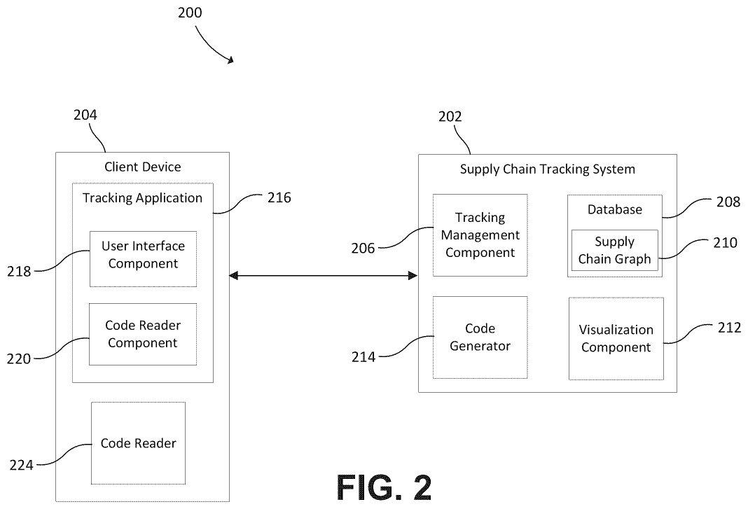

In accordance with the disclosure, supply chain tracking service includes a supply chain tracking system 118 which enables goods to be tracked from source (e.g., farm, manufacturer, factory, etc.) to destination (e.g., distributors, stores, warehouses, etc.). An example implementation of supply chain tracking system 200 is shown in FIG. 2. Supply chain tracking system 200 includes a tracking management component 206, a database 208, a visualization component 212, and a code generator 214. These components are implemented on one or more computing devices (e.g., servers, personal computers, and the like).

The tracking management component 206 receives tracking data from client devices, such as client device 204, and in particular, a tracking application 216 being executed on the client device 204. Tracking application 216 enables users of the client device 204 to interact with the supply chain tracking system, e.g., by adding/updating product and location information for the system and visualizing various aspects of the supply chain (explained in more detail below). The tracking application 216 includes a user interface component 218 which is displayed on a display device of the client device and includes various user interface controls for receiving user input via a user input device, such as a mouse, keyboard, pen, touchscreen, and the like, and displaying information related to the tracking system 202. Client device 204 includes or works with a code reader, such as a barcode scanner, AR code scanner, RFID scanner, and/or the like. Tracking application 216 includes a code reader component 220 that enables code reader 224 to be accessed and controlled to read product and location into the tracking application.

The tracking management component 206 receives tracking data for products and locations in a supply chain and generates and maintains a supply chain graph 210 in a database 208. In various implementations, the tracking management component utilizes group-by-aggregation queries on the database records corresponding to connections between nodes. Graphs may be generated in any suitable manner. In various implementations, the database is a Microsoft Azure SQL database, and the supply chain graph is stored in a ledger table in the database. In various implementations, the product and location tracking data are used to generate a supply chain graph including multiple nodes and edges which extend between the nodes. Each node in the graph corresponds to locations/transports used in a supply chain, such as farm, storage (e.g., warehouse, silo, etc.), packaging facility, transport (e.g., truck, cargo ship, etc.), distribution, retail store, and the like. A unique tracker code is associated with each location (also referred to as a location code) and transport (also referred to as a transport code) in the supply chain. Each edge between two nodes represents the product(s) that are being transferred between nodes. Each product is associated with a unique tracker code (also referred to as a product code). Tracker codes for locations, transports and products may be predetermined or generated as needed. For example, the tracking system 202 may include a code generator 214 if needed for generating codes.

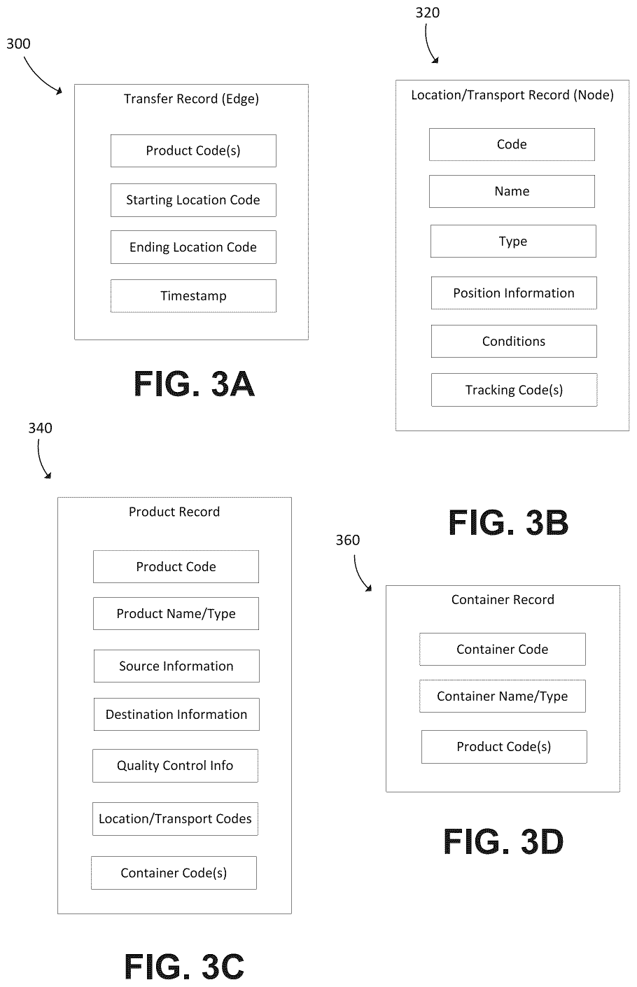

Each edge between two nodes corresponds to a record in the database (e.g., ledger table). An example schema for a transfer record 300 is shown in FIG. 3A. The transfer record 300 includes a product code for each product being transferred between two given nodes. The record 300 also includes a starting location/transport code which identifies the location/transport that the product(s) is being transferred from and an ending location code which identifies the location/transport the product(s) is being transferred to. The record 300 may also include a timestamp indicating the time the products were transferred from the starting location to the ending location. A transfer record may include any other information as needed for recording and tracking the movement of products from one stage of a supply chain to the next.

Location/transport information and product information may be stored in a similar manner as the supply chain record. For example, location/transport information may be stored in a location/transport record and product information may be stored in a product record. An example schema for a location/transport record 320 is shown in FIG. 3B. The location/transport record includes code, name, and type for storing the location/transport code, location/transport name, and location/transport type, respectively. The record 320 also includes position information (e.g., address, latitude-longitude data, etc.). For transports, the position information includes at least the current position of the transport. Depending on the implementation, the position information may list positions tracked over time as the transport moves from one location to another. The location/transport record may also include conditions information which indicates environmental conditions (e.g., temperature, weather, etc.) at or in the location/transport. The location/transport record 320 also includes a list of product codes for the products which are currently located at/in the location/transport. Other product tracking information may be recorded to facilitate tracking of products through the supply chain. For example, for bulk products, such as grains, the other product tracking information may include information volume per unit information for a product. For example, for bulk products, such as grains, volumes of grain are aggregated in silos. Different volumes of grains may be given different product codes which enables the volume per unit (e.g., percentage of the total grain supply in a silo) for each volume of grain to be tracked. This information may be used for probabilistic tracking which may be used for tracking bulk commodities which are intermixed when aggregated.

FIG. 3C shows an example schema for a product record 340 for storing product tracking data for products in the supply chain. As shown in FIG. 3C, the product record 340 lists the product code for the product and the name and/or type of product. The product record 340 also includes source information. The source information identifies the source of the product, such as the farm, plant, or factory, where the product originated. The source information may include other information pertaining to the source of the product, such as location, sustainability certifications, quality control metrics, and/or any other information pertaining to the source of the product. The product record 340 may include destination information if a final destination for the product is known. The product record 340 may also include quality control information, such as transport/storage conditions. The quality control information may identify how long the product has been in the supply chain and/or how long the product was at each location or in each transport. The record includes a list of location/transport codes that the product has been associated with.

Products may be packaged and grouped in a number of ways which may be tracked by the system. For example, products may be packaged and then grouped into cases, stacked on pallets, loaded into Conex boxes, etc. The product record may include container information for indicating the current container (and previous containers) where the product is located (e.g., box, case, pallet, and the like). Container information may be tracked in a similar manner as locations, transports, and products. An example schema for a container record 360 is shown in FIG. 3D. The container record 360 includes a unique tracking code (also referred to as a container code). The container record may also list the name/type of container (e.g., box, pallet, Conex container, etc.). The container record also includes a list of the product codes for the products currently contained in the container. In some implementations, supply chain records and location/transport records may list container codes rather than individual product codes if container records are utilized.

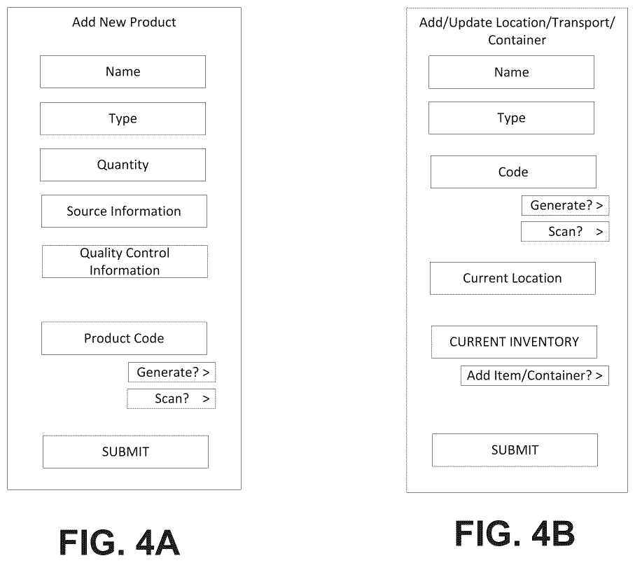

Information for adding/populating/updating location, transport, container, and product records can be entered via the user interface component 218. FIGS. 4A and 4B show example implementations user interfaces for adding/updating product records and adding/updating location/transport/container records, respectively. In FIG. 4A, the user interface includes fields for entering/selecting name, type, quantity, source information, and quality control information. When new products are added to a supply chain, the system may be configured to generate product codes. New product codes can be generated by the system if needed or scanned in if product codes (e.g., barcode stickers and the like) have already been provided. Similarly, tracking codes for new locations, transports, and containers can be generated by the system or scanned in if codes have already been provided, as shown in FIG. 4B. Adding a product to a location, transport, or container may involve selecting the location, transport, or container from a list and using the code reader component 220 to scan the product code for the product to add it to the location, transport, or container.

Database records are updated as products move through the supply chain. For example, each time a product is added to a location, transport, or container, the product record is updated to include the location, transport, and/or container code to which it was added, and the location, transport, and/or container records are updated to include the product code for the products added thereto. The tracking scheme can be used in both deterministic tracking schemes and probabilistic tracking schemes. Deterministic tracking may be used for quantifiable and separate product entities (e.g., discrete items, packs, or pallets) in which case the tracking codes form a deterministic link between the current code and previous codes.

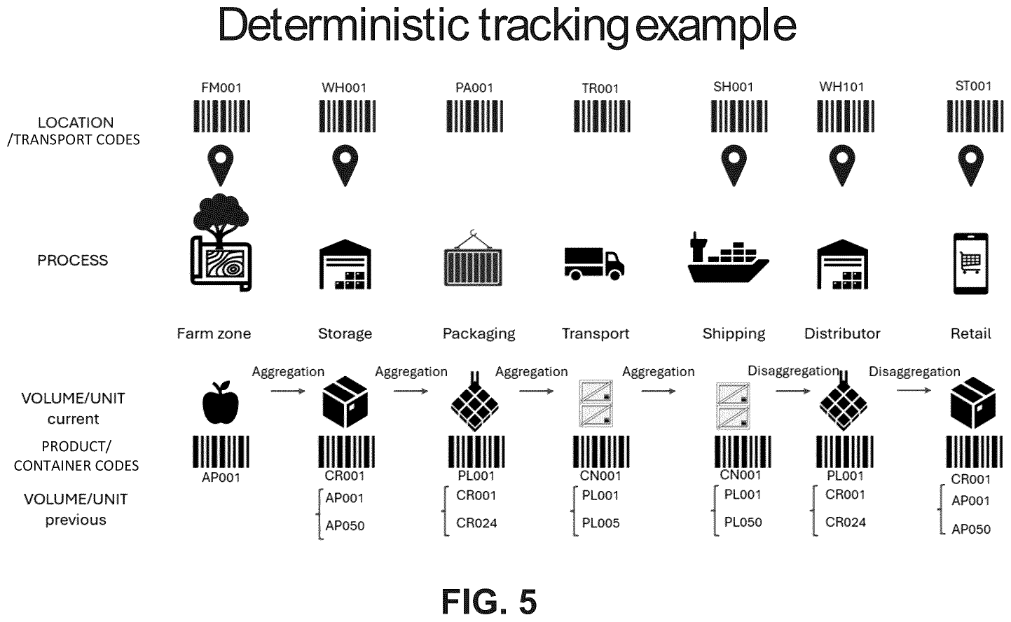

A schematic view of an example on how deterministic tracking may be implemented using location, transport, and products codes is shown in FIG. 5. The supply chain of FIG. 5 includes farm zone (i.e., source), storage, packaging, transport, shipping, distributor, and retail stages. As can be seen in FIG. 5, each location (e.g., farm zone, storage, packaging, distributor, and retail) has been assigned a location code, and each transport (e.g., transport truck and shipping) is assigned a transport code. The products at the farm zone (e.g., apples) are given product codes (e.g., AP001-AP050). The product is added to a container, such as a crate, and stored at the storage location. The product codes AP001-AP050 for the products are then stored in association with the container code for the crate (i.e., CR001), and the container code is stored in association with the location code for the storage location (i.e., WH001).

The crate CR001 is then palletized along with a plurality of other crates (i.e., CR002-CR0024) at the packaging stage. In this case, the container codes CR001-CR024 are stored in association with the container code for the pallet (i.e., PL001) indicating that those crates (along with the products they contain) are on the pallet. The pallet PL001 is then added to a Conex container (i.e., CN001) along with pallets PL002-PL005, and the container codes (PL001-PL005) are stored in association with container code CN001. The Conex container CN001 is added to the cargo ship for transportation to the distributor. When the cargo ship reaches its destination, the cargo from the ship is disaggregated which results in the pallet PL001 (which contains crates CR001-CR024) being disaggregated from the Conex container CN001. Further disaggregation of the product occurs as crate CR001 (which contains products AP001-AP050) is disaggregated from pallet PL001 and delivered to the retail store.

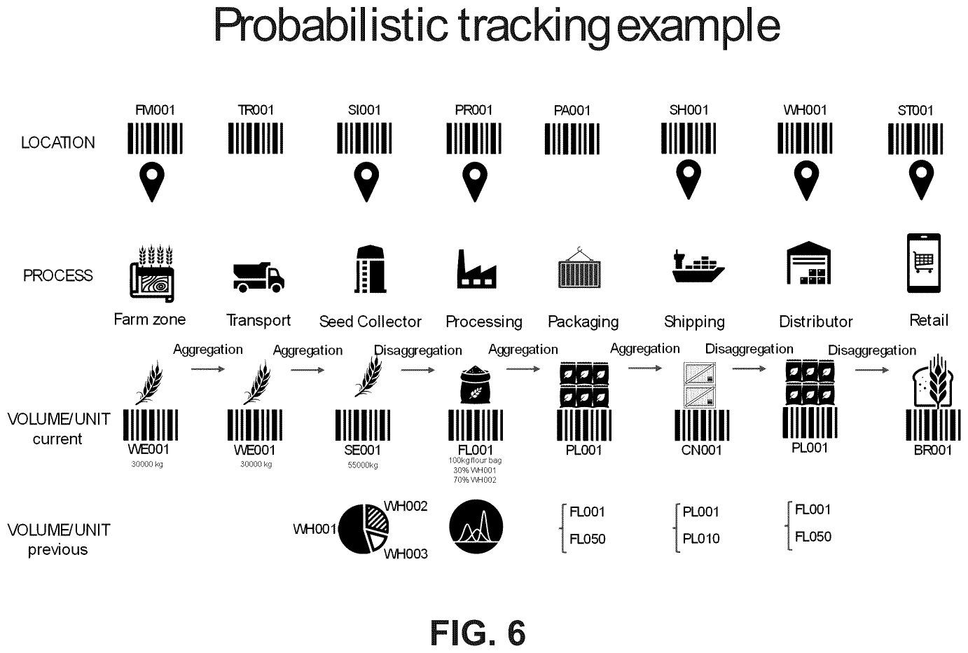

For volumetric bulk commodities (e.g., volumes of grain), probabilistic tracking is used to create a probabilistic association based on aggregation and disaggregation volumes. A probabilistic tracking example will now be discussed with reference to FIG. 6. In the example of FIG. 6, grain harvested from a farm is given a product code based on volume associated with a management zone. This grain is then stored by volume in silos with volumes aggregated one after the other. The grain is then extracted by volume from the silos and transported to seed collectors. The farm zone, transport, and seed collector are each assigned a location/transport code. For example, the product code (i.e., WE001) for the volume of grain from the farm zone (i.e., FM001) is added to the records for the farm zone (i.e., FM001) and the transport (i.e., TR001) from the farm zone to the seed collector.

At this point, grain from multiple farms is combined into larger storage silos. In this example, the product codes for volumes of grain (e.g., WE001-WE003) from different farms are added to a larger storage silo (e.g., SE001) at the seed collector. As can be seen in the bottom row of the example, volume per unit information is tracked which indicates how much of the total volume of grain in the silo SE001 is made up of each volume of grain. The grain is then processed (processing stage PR001), e.g., by grinding, to produce a volume of flour. The flour is then disaggregated and packaged to produce fixed volume packages of flour. Each package is given a product code (i.e., FL001-FL050).

The packages are then added (at packaging stage PA001) to a pallet, and the tracking codes (FL001-FL050) are stored in association with the container code for the pallet (i.e., PL001). The pallet PL001 is added to a Conex container (i.e., CN001) along with pallets PL002-PL005 for shipping to a distributor, and the container codes for the pallets (PL001-PL005) are stored in association with container code for the Conex container (i.e., CN001). The Conex container CN001 is added to the cargo ship for transportation to the distributor. At the distributor, pallet PL001 is disaggregated from the Conex container and delivered to a retail store which makes bread in this example. The product codes for the flour packages may then be stored in association with the product code for the bread (i.e., BR001) made by the retail store.

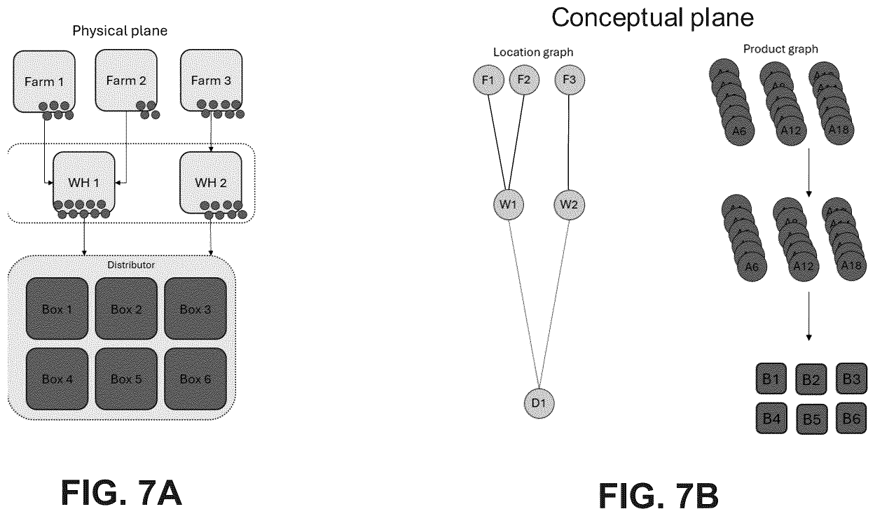

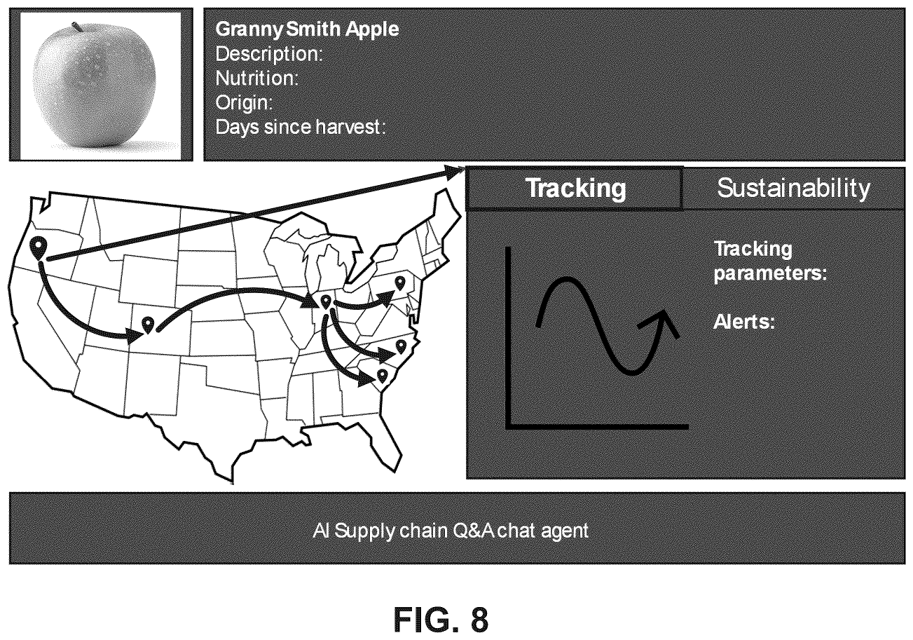

The supply chain tracking system includes a visualization component 212 which is configured to generate visualizations from the tracking information in the supply chain graph. Examples of such visualizations are shown in FIGS. 7A, 7B, and 8. FIG. 7A shows a visualization of a supply chain from farm to distributor in the form of a graph which shows the locations and the products at each stage in the supply chain. The supply chain in this example includes farms (e.g., Farm 1, Farm 2, Farm 3) which each have products (as indicated by the red circles within each farm icon). The products from the farms are stored in warehouses (e.g., WH 1, WH 2). The products from Farm 1 and Farm 2 are aggregated in warehouse WH 1. The products from Farm 3 are stored in warehouse WH 2. The products are then delivered to a distributor where the products are aggregated into boxes (e.g., Box 1-Box 6). This graph is useful to the packaging state of products as they go through the supply chain from farm to distributor.

FIG. 7B shows conceptual graphs of the supply chain. For example, the graph on the left is a simple location graph which shows the stages of the supply chain from farm to distributor and how products are routed between stages, but without providing any information regarding the products that are being moved between stages. The location graph provides a simplified view of how a product is or will be moved through the supply chain. The graph on the right-hand side of FIG. 7B is a product graph which shows the products that are being moved at each stage/location in the supply chain without showing what the stages/locations are. This view is useful for seeing the quantity of products and how products are aggregated or disaggregated at each stage in the supply chain.

FIG. 8 shows another visualization that is enabled by generating and maintaining a supply chain graph as described above. As shown in FIG. 8, the visualization component is capable of generating a map view which may be used to show the movement of products through a supply chain by showing the physical locations where each stage in a supply chain is located on a map. In the example of FIG. 8, the visualization can include an image and/or description of the product that is being tracked. The image can be specific to the source of the product or can be a generic image of the product. Similarly, the description can be specific to the source of the product or can be a high-level description of the product. The visualization can also show a map of the supply chain for the product. The stages of the supply chain may be indicated by map pins, or other type of indicator, which point to the map locations where the stages of the supply chain are located. Arrows show the direction of movement from one stage to the next. Map pin icons and arrows may be clicked on to obtain more information pertaining to the product. For example, clicking on a map pin can cause information on the product code for the product at that location along with information on tracking, sustainability, quality, etc. In addition to visualizations, the tracking system may be capable of receiving queries on products, tracking data, and supply chain information via the tracking application. The tracking system may utilize artificial intelligence (AI) agents to provide answers to such queries. An AI agent, such as a machine learning model, can be trained to process tracking codes, tracked data, product information, supply chain information, and other relevant information in order to provide domain-specific answers to user queries.

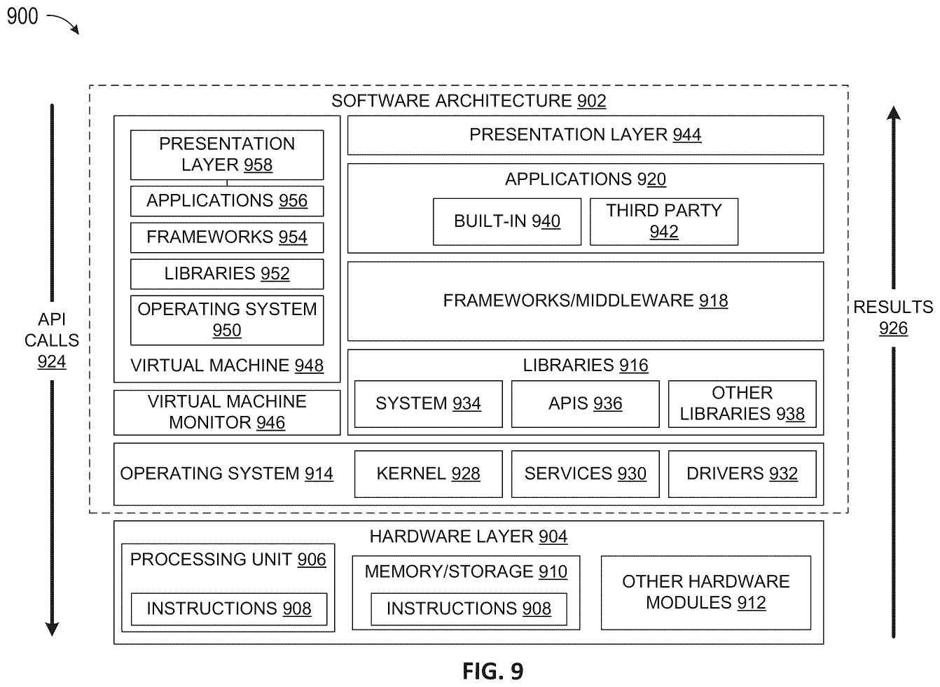

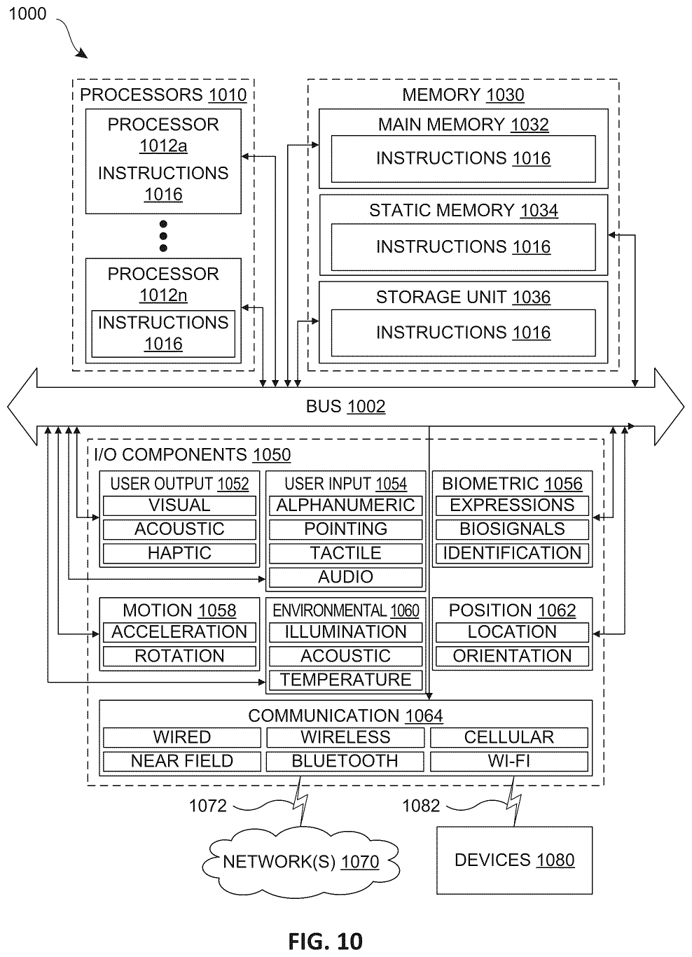

FIG. 9 is a block diagram 900 illustrating an example software architecture 902, various portions of which may be used in conjunction with various hardware architectures herein described, which may implement any of the above-described features. FIG. 9 is a non-limiting example of a software architecture and it will be appreciated that many other architectures may be implemented to facilitate the functionality described herein. The software architecture 902 may execute on hardware such as a machine 1000 of FIG. 10 that includes, among other things, processors 1010, memory 1030, and input/output (I/O) components 1050. A representative hardware layer 904 is illustrated and can represent, for example, the machine 1000 of FIG. 10. The representative hardware layer 904 includes a processing unit 906 and associated executable instructions 908. The executable instructions 908 represent executable instructions of the software architecture 902, including implementation of the methods, modules and so forth described herein. The hardware layer 904 also includes a memory/storage 910, which also includes the executable instructions 908 and accompanying data. The hardware layer 904 may also include other hardware modules 912. Instructions 908 held by processing unit 906 may be portions of instructions 908 held by the memory/storage 910.

The example software architecture 902 may be conceptualized as layers, each providing various functionality. For example, the software architecture 902 may include layers and components such as an operating system (OS) 914, libraries 916, frameworks 918, applications 920, and a presentation layer 944. Operationally, the applications 920 and/or other components within the layers may invoke API calls 924 to other layers and receive corresponding results 926. The layers illustrated are representative in nature and other software architectures may include additional or different layers. For example, some mobile or special purpose operating systems may not provide the frameworks/middleware 918.

The OS 914 may manage hardware resources and provide common services. The OS 914 may include, for example, a kernel 928, services 930, and drivers 932. The kernel 928 may act as an abstraction layer between the hardware layer 904 and other software layers. For example, the kernel 928 may be responsible for memory management, processor management (for example, scheduling), component management, networking, security settings, and so on. The services 930 may provide other common services for the other software layers. The drivers 932 may be responsible for controlling or interfacing with the underlying hardware layer 904. For instance, the drivers 932 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 916 may provide a common infrastructure that may be used by the applications 920 and/or other components and/or layers. The libraries 916 typically provide functionality for use by other software modules to perform tasks, rather than rather than interacting directly with the OS 914. The libraries 916 may include system libraries 934 (for example, C standard library) that may provide functions such as memory allocation, string manipulation, file operations. In addition, the libraries 916 may include API libraries 936 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 916 may also include a wide variety of other libraries 938 to provide many functions for applications 920 and other software modules.

The frameworks 918 (also sometimes referred to as middleware) provide a higher-level common infrastructure that may be used by the applications 920 and/or other software modules. For example, the frameworks 918 may provide various graphic user interface (GUI) functions, high-level resource management, or high-level location services. The frameworks 918 may provide a broad spectrum of other APIs for applications 920 and/or other software modules.

The applications 920 include built-in applications 940 and/or third-party applications 942. Examples of built-in applications 940 may include, but are not limited to, a contacts application, a browser application, a location application, a media application, a messaging application, and/or a game application. Third-party applications 942 may include any applications developed by an entity other than the vendor of the particular platform. The applications 920 may use functions available via OS 914, libraries 916, frameworks 918, and presentation layer 944 to create user interfaces to interact with users.

Some software architectures use virtual machines, as illustrated by a virtual machine 948. The virtual machine 948 provides an execution environment where applications/modules can execute as if they were executing on a hardware machine (such as the machine 1000 of FIG. 10, for example). The virtual machine 948 may be hosted by a host OS (for example, OS 914) or hypervisor, and may have a virtual machine monitor 946 which manages operation of the virtual machine 948 and interoperation with the host operating system. A software architecture, which may be different from software architecture 902 outside of the virtual machine, executes within the virtual machine 948 such as an operating system 950, libraries 952, frameworks 954, applications 956, and/or a presentation layer 958.

FIG. 10 is a block diagram illustrating components of an example machine 1000 configured to read instructions from a machine-readable medium (for example, a machine-readable storage medium) and perform any of the features described herein. The example machine 1000 is in a form of a computer system, within which instructions 1016 (for example, in the form of software components) for causing the machine 1000 to perform any of the features described herein may be executed. As such, the instructions 1016 may be used to implement modules or components described herein. The instructions 1016 cause unprogrammed and/or unconfigured machine 1000 to operate as a particular machine configured to carry out the described features. The machine 1000 may be configured to operate as a standalone device or may be coupled (for example, networked) to other machines. In a networked deployment, the machine 1000 may operate in the capacity of a server machine or a client machine in a server-client network environment, or as a node in a peer-to-peer or distributed network environment. Machine 1000 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1000 is illustrated, the term “machine” includes a collection of machines that individually or jointly execute the instructions 1016.

The machine 1000 may include processors 1010, memory 1030, and I/O components 1050, which may be communicatively coupled via, for example, a bus 1002. The bus 1002 may include multiple buses coupling various elements of machine 1000 via various bus technologies and protocols. In an example, the processors 1010 (including, for example, a central processing unit (CPU), a graphics processing unit (GPU), a digital signal processor (DSP), an ASIC, or a suitable combination thereof) may include one or more processors 1012a to 1012n that may execute the instructions 1016 and process data. In some examples, one or more processors 1010 may execute instructions provided or identified by one or more other processors 1010. The term “processor” includes a multi-core processor including cores that may execute instructions contemporaneously. Although FIG. 10 shows multiple processors, the machine 1000 may include a single processor with a single core, a single processor with multiple cores (for example, a multi-core processor), multiple processors each with a single core, multiple processors each with multiple cores, or any combination thereof. In some examples, the machine 1000 may include multiple processors distributed among multiple machines.

The memory/storage 1030 may include a main memory 1032, a static memory 1034, or other memory, and a storage unit 1036, both accessible to the processors 1010 such as via the bus 1002. The storage unit 1036 and memory 1032, 1034 store instructions 1016 embodying any one or more of the functions described herein. The memory/storage 1030 may also store temporary, intermediate, and/or long-term data for processors 1010. The instructions 1016 may also reside, completely or partially, within the memory 1032, 1034, within the storage unit 1036, within at least one of the processors 1010 (for example, within a command buffer or cache memory), within memory at least one of I/O components 1050, or any suitable combination thereof, during execution thereof. Accordingly, the memory 1032, 1034, the storage unit 1036, memory in processors 1010, and memory in I/O components 1050 are examples of machine-readable media.

As used herein, “machine-readable medium” refers to a device able to temporarily or permanently store instructions and data that cause machine 1000 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1016) for execution by a machine 1000 such that the instructions, when executed by one or more processors 1010 of the machine 1000, cause the machine 1000 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1050 may include a wide variety of hardware components adapted to receive input, provide output, produce output, transmit information, exchange information, capture measurements, and so on. The specific I/O components 1050 included in a particular machine will depend on the type and/or function of the machine. For example, mobile devices such as mobile phones may include a touch input device, whereas a headless server or IoT device may not include such a touch input device. The particular examples of I/O components illustrated in FIG. 10 are in no way limiting, and other types of components may be included in machine 1000. The grouping of I/O components 1050 are merely for simplifying this discussion, and the grouping is in no way limiting. In various examples, the I/O components 1050 may include user output components 1052 and user input components 1054. User output components 1052 may include, for example, display components for displaying information (for example, a liquid crystal display (LCD) or a projector), acoustic components (for example, speakers), haptic components (for example, a vibratory motor or force-feedback device), and/or other signal generators. User input components 1054 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1050 may include biometric components 1056, motion components 1058, environmental components 1060, and/or position components 1062, among a wide array of other physical sensor components. The biometric components 1056 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1058 may include, for example, acceleration sensors (for example, an accelerometer) and rotation sensors (for example, a gyroscope). The environmental components 1060 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1062 may include, for example, location sensors (for example, a Global Position System (GPS) receiver), altitude sensors (for example, an air pressure sensor from which altitude may be derived), and/or orientation sensors (for example, magnetometers).

The I/O components 1050 may include communication components 1064, implementing a wide variety of technologies operable to couple the machine 1000 to network(s) 1070 and/or device(s) 1080 via respective communicative couplings 1072 and 1082. The communication components 1064 may include one or more network interface components or other suitable devices to interface with the network(s) 1070. The communication components 1064 may include, for example, components adapted to provide wired communication, wireless communication, cellular communication, Near Field Communication (NFC), Bluetooth communication, Wi-Fi, and/or communication via other modalities. The device(s) 1080 may include other machines or various peripheral devices (for example, coupled via USB).

In some examples, the communication components 1064 may detect identifiers or include components adapted to detect identifiers. For example, the communication components 1064 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 1064, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A supply chain tracking system comprising:
a processor; and
a memory in communication with the processor, the memory comprising executable instructions that, when executed by the processor alone or in combination with other processors, cause the supply chain tracking system to perform functions of:
storing node information for a plurality of nodes of a supply chain graph in a database, each of the nodes representing a stage in the supply chain;
receiving first product tracking information for a first product unit via a network, the first product tracking information including a first tracking code associated with the first product unit and indicating a first node for the first product unit;
receiving second product tracking information via the network, the second product tracking information indicating that a plurality of product units have been aggregated to form a first aggregation of product units at a second node of the plurality of nodes and the second product tracking information including (i) a second tracking code associated with the first aggregation of product units and (ii) a first list of tracking codes for the product units in the first aggregation of product units, the first list of tracking codes including the first tracking code; and
storing a first record in the database indicating a transfer of the first product unit from the stage associated with the first node to the stage associated with the second node, the first record corresponding to a first edge of the supply chain graph and including the first tracking code, the second tracking code, a first location code associated with the first node, and a second location code associated with the second node.

2. The supply chain tracking system of claim 1, wherein the functions further comprise:
receiving third product tracking information via the network, the third product tracking information indicating that a plurality of aggregations of product units have been aggregated to form a second aggregation at a third node of the plurality of nodes and including (i) a third tracking code associated with the second aggregation and (ii) a second list of tracking codes for the aggregations of product units in the first aggregation, the second list of tracking codes including the second tracking code; and
storing a second record in the database indicating a transfer of the first product unit from the second stage associated with the second node to a third stage of the supply chain associated with the third node, the second record corresponding to a second edge in the supply chain graph and including the first tracking code, the second tracking code, the third tracking code, the second location code associated with the second node, and a third location code associated with the third node.

3. The supply chain tracking system of claim 1, wherein the functions further comprise:
receiving third product tracking information via the network, the third product tracking information indicating that the first product unit has been disaggregated from the first aggregation at a third node of the plurality of nodes; and
storing a second record in the database indicating a transfer of the first product unit from the second stage associated with the second node to a third stage of the supply chain associated with the third node, the second record including the first tracking code, the second location code associated with the second node, and a third location code associated with the third node.

4. The supply chain tracking system of claim 1, wherein:
the first tracking code is included with the first product unit, and
the first product tracking information is generated by scanning the first tracking code with a code reader of a client device.

5. The supply chain tracking system of claim 1, wherein:
the first aggregation corresponds to a pallet on which the product units have been stacked, and
the second tracking code is a code for the pallet.

6. The supply chain tracking system of claim 1, wherein:
the first node corresponds to a source node for the first product unit, and
the node information includes source information for the source node, the source information indicating at least one quality metric for the first product unit.

7. The supply chain tracking system of claim 1, wherein the product units in the first aggregation of product units including the first product unit are each a volume of a bulk commodity.

8. The supply chain tracking system of claim 1, wherein the supply chain graph is generated utilizing group-by aggregation queries on records in the database.

9. The supply chain tracking system of claim 1, wherein the functions further comprise:
generating a visualization of the supply chain graph based on the plurality of nodes and at least the first edge and the second edge, and
displaying the visualization of the supply chain graph on a display device.

10. The supply chain tracking system of claim 8, wherein the visualization includes:
a map of a geographic region associated with the plurality of nodes of the supply chain,
pin icons pointing to locations on the map where the plurality of nodes of the supply chain are physically located.

11. The supply chain tracking system of claim 8, wherein user interaction with a pin icon causes information to be displayed on a display screen pertaining to the location pointed to by the pin icon.

12. A method of tracking products in a supply chain using a supply chain tracking system, the method comprising:
receiving a first notification indicating that a first product unit is to be added to a first stage of the supply chain, the first notification including first product information;
determining a first tracking code for the first product unit;
generating a first product record in a database for the supply chain tracking system, the database storing node information for a plurality of nodes of a supply chain graph representing the supply chain, each of the nodes representing different stages of the supply chain, the first product record including the first tracking code, the first product information, and a first location code for the product unit, the first location code for the product unit corresponding to a location code assigned to the first stage;
receiving a second notification indicating that a first container unit is to be added to the first stage of the supply chain, the second notification including first container information;
determining a second tracking code for the container unit;
generating a first container record in the database for the supply chain tracking system, the first container record including the second tracking code, the first container information, and the first location code;
receiving a third notification indicating that the first tracking code is associated with the second tracking code;
updating the first product record to include the second tracking code and the first container record to include the first tracking code;
receiving a fourth notification indicating a transfer of the first container unit to a second stage of the supply chain;
updating the first product record and the first container record to include a second location code corresponding to a location code for the second stage; and
generating a first transfer record in the database for the transfer of the first container unit to a second stage of the supply chain, the first transfer record including the first location code, the second location code, and at least the second tracking code.

13. The method of claim 12, further comprising:
receiving a fifth notification indicating the second tracking code is associated with a third tracking code, the third tracking code being for a second container unit;
updating the first record and the second record to include the third tracking code, and updating a container record for the second container unit to include at least the second tracking code.

14. The method of claim 13, further comprising:
receiving a sixth notification indicating a transfer of the second container unit to a third stage of the supply chain;
updating the first product record, the first container record, and the second container record to include a third location code, the third location code corresponding to a location code for the third stage; and
generating a second transfer record in the database for the transfer of the second container unit to the third stage of the supply chain, the second transfer record including the second location code, the third location code, and at least the third tracking code.

15. The method of claim 14, further comprising:
receiving a request to generate a map view of product movement in the supply chain for the first product unit via a user interface of the supply chain tracking system;
accessing the database to identify transfer records associated with the first tracking code;
generating a visualization based on sources and destinations of the transfer records associated with the first tracking code; and
displaying the visualization on a display device associated with the request.

16. The method of claim 15, wherein the visualization includes:
a map of a geographic region indicating the sources and destinations of the transfer records for the first tracking code.

17. The method of claim 16, further comprising:
receiving user input indicating a selection of one of the sources and destinations;
accessing the database to retrieve location information pertaining to the selection; and
displaying the location information on the display device.

18. A non-transitory computer readable medium on which are stored instructions that, when executed, cause a programmable device to perform functions of:
storing node information for a plurality of nodes of a supply chain graph in a database, each of the nodes representing a stage in the supply chain;
receiving first product tracking information for a first product unit via a network, the first product tracking information including a first tracking code associated with the first product unit and indicating a first node for the first product unit;
receiving second product tracking information via the network, the second product tracking information indicating that a plurality of product units have been aggregated to form a first aggregation of product units at a second node of the plurality of nodes and the second product tracking information including (i) a second tracking code associated with the first aggregation of product units and (ii) a first list of tracking codes for the product units in the first aggregation of product units, the first list of tracking codes including the first tracking code; and
storing a first record in the database indicating a transfer of the first product unit from the stage associated with the first node to the stage associated with the second node, the first record corresponding to a first edge of the supply chain graph and including the first tracking code, the second tracking code, a first location code associated with the first node, and a second location code associated with the second node.

19. The non-transitory computer readable medium of claim 18, wherein the functions further comprise:
receiving third product tracking information via the network, the third product tracking information indicating that a plurality of aggregations of product units have been aggregated to form a second aggregation at a third node of the plurality of nodes and including (i) a third tracking code associated with the second aggregation and (ii) a second list of tracking codes for the aggregations of product units in the first aggregation, the second list of tracking codes including the second tracking code; and
storing a second record in the database indicating a transfer of the first product unit from the second stage associated with the second node to a third stage of the supply chain associated with the third node, the second record corresponding to a second edge in the supply chain graph and including the first tracking code, the second tracking code, the third tracking code, the second location code associated with the second node, and a third location code associated with the third node.

20. The non-transitory computer readable medium of claim 18, wherein the functions further comprise:
receiving third product tracking information via the network, the third product tracking information indicating that the first product unit has been disaggregated from the first aggregation at a third node of the plurality of nodes; and
storing a second record in the database indicating a transfer of the first product unit from the second stage associated with the second node to a third stage of the supply chain associated with the third node, the second record including the first tracking code, the second location code associated with the second node, and a third location code associated with the third node.
